(19) United States
(12) Patent Application Publication
(10) Pub. No.: US 2012/0284305 A1
(43) Pub. Date: Nov. 8, 2012

(54) TREND INFORMATION SEARCH DEVICE, TREND INFORMATION SEARCH METHOD AND RECORDING MEDIUM

(75) Inventor: Hideki Kawai, Tokyo (JP)

(73) Assignee: NEC Corporation, Tokyo (JP)

(21) Appl. No.: 13/574,148

(22) PCT Filed: Jan. 18, 2011
(86) PCT No.: PCT/JP2011/050783

§ 371 Date: Jul. 19, 2012

(30) Foreign Application Priority Data
Jan. 19, 2010 (JP) 2010-009085

(51) Int. Cl. G06F 17/30

(52) U.S. Cl. 707/769; 707/E17.014; 707/E17.008

(57) ABSTRACT

In trend information search device, an expanded query generator generates an expanded query by adding, as search conditions, trend information element to the input search conditions containing the search keyword, wherein the trend information element is a character string of a natural language characteristically appears in documents containing the trend information. A searcher searches external document data using the expanded query. A trend information evaluator evaluates the degree to which the trend information for the statistical quantities satisfying the input conditions are contained in a document searched by the searcher, based on the occurrence status of the trend information element and the input search keyword in the document.

### TECHNICAL FIELD

The present invention relates to a trend information search device, trend information search method and recording medium.

### BACKGROUND ART

Surveying and evaluating trends in business performance and economic indicators is an important process for investment decisions. Systems have been proposed to make this process more efficient and aid in making appropriate investment decisions.

For example, Patent Literature 1 discloses a data estimation assistance system for assisting investors and/or the like in taking investment decisions. This data decision assistance system comprises an asset price database (DB) that stores chronological data such as company stock prices and foreign exchange rates, an economic indicator DB that stores chronological data such as gross domestic product and crude oil prices, and a news DB that stores news articles. This data decision assistance system uses these databases to graphically display fluctuations in the foreign exchange market and fluctuations in Dubai crude oil prices and also display related news during that period.

In addition, Patent Literature 2 discloses a stock price information collection and analysis system that analyzes what the typical investor is expecting and determines which information related to stock price is information intended to manipulate the stock price, on the basis of the analysis results.

In addition, technology for assisting in information analysis is disclosed in Patent Literature 3-6.

A document data providing device according to Patent Literature 3 extracts words from dated document data, tallies the number of words for each word in each field and period, finds the occurrence frequencies of these words and extracts as characteristic words a constant number of words with a large occurrence frequency in each field and each period. With this document data providing device, the field and period are specified by a user, and the characteristic words of document data in that period are displayed and if designated characteristic words are selected the document headlines and/or the like of document data containing those characteristic words are displayed.

The information analysis system according to Patent Literature 4 stores collected information, geographical condition information and scope condition information, and links the collected information and geographical condition information based on the scope condition information. This information analysis system merges the collected information and the geographical condition information associated therewith and analyzes as merge information the information for which this association has been made.

Patent Literature 5 discloses a data processing device for displaying changes in trend information and the causes thereof. A trend information extraction unit in the data processing device extracts trend information that is subject to processing from an acquired corpus. A factor information extraction unit extracts information conjectured to be causes of change in extracted trend information. An essential word extraction unit extracts essential words conjectured to be useful in analysis of trend information. A trend information display unit generates graphs displaying fluctuations in the extracted trend information. A cause information display unit displays on the graph generated by the trend information display unit cause information that are causes of trend information fluctuation. The factor information display unit extracts and displays cause information useful in trend information analysis in accordance with prescribed conditions.

Patent Literature 6 discloses technology for providing feedback information to a user for improving queries. A query examination device according to Patent Literature 6 examines queries using degree of selection related to image/object meanings and external appearance characteristics, and provides feedback information to the user. The feedback information includes the maximum number and minimum of matches to the query, suggested alternatives to query elements (meaning and external appearance characteristics), and estimated number of images matching the query.

### PRIOR ART LITERATURE

Patent Literature 1: Unexamined Japanese Patent Application Kokai Publication No. 2007-087354

Patent Literature 2: Unexamined Japanese Patent Application Kokai Publication No. 2009-163598

Patent Literature 3: Unexamined Japanese Patent Application Kokai Publication No. 2000-172701

Patent Literature 4: Unexamined Japanese Patent Application Kokai Publication No. 2005-128893

Patent Literature 5: Unexamined Japanese Patent Application Kokai Publication No. 2007-241905

Patent Literature 6: Unexamined Japanese Patent Application Kokai Publication No. H11-328185.

### DISCLOSURE OF INVENTION

### Problems to be Solved by the Invention

A first problem in the technology according to Patent Literature 1-6 is that it is necessary for the systems to possess in advance a statistical database that is the subject of analysis, such as economic indicators and/or the like, and business performance that is the subject of analysis. Consequently, analysis about statistics not stored in a database is impossible.

For example, with the technology according to Patent Literature 1-6, to extract and analyze causes of change in statistics relating to an arbitrary topic in which a user is interested, for example “I want to know what factors caused a decline in total sales at Company N in 2001”, analysis is difficult if data related to Company N's total sales and related news were not stored in advance.

As a method of acquiring arbitrary statistical data from an outside corpus such as the Web, for example a method can be conceived for searching such with an Internet search engine using an query composed of multiple keywords with AND operator, for example “2001 AND Company N AND total sales”. However, the desired statistical quantity information is not necessarily included in a document containing these keywords. For example, documents that are hits with the “2001 AND Company N AND total sales” search could contain noise documents relating to help wanted information or a company overview in a press release, and/or the like. Because the company name, total sales for the most recent fiscal year and company history are noted in the company overview, what is noted in that document is Company N's total sales for fiscal 2008, but “2001 AND Company N AND total sales” could produce hits if the document contains “contact center established in 2001” and/or the like as part of the company history.

On the other hand, a document relating to statistical trends targeted for search could be said to conform to the user's interest, such as “Company N announced interim earnings for the period ended September 2001, with total sales down 0.4% from the same period a year earlier to 2.468 trillion yen”. In this manner, such documents related to the statistical trends satisfying the user's interest could be found through search an external corpus.

In consideration of the foregoing, it is an object of the present invention to provide a trend information search device, a trend information search method and a recording medium that can automatically obtain documents containing statistical trend information from an external corpus.

### Means for Solving the Problems

The trend information search device according to a first aspect of the present invention is a trend information search device comprising:

expanded query generation means that generates an expanded query by adding, as search conditions, trend information elements to the input search conditions, wherein the trend information elements is a character string of natural language and characteristically appears in documents containing trend information;

search means that searches external data using the query generated by the expanded query generation means; and

trend information evaluation means that evaluates the degree to which trend information for statistical quantities satisfying the input conditions are contained in a document searched by the search means, based on the occurrence status of the trend information elements in the document.

The trend information search method according to a second aspect of the present invention is a trend information search method comprising:

an expanded query generation step for generating an expanded query by adding, as search conditions, trend information elements to the input search conditions, wherein the trend information elements is a character string of natural language and characteristically appears in documents containing trend information;

a search step for searching external data using the query generated by the expanded query generation step; and

a trend information evaluation step for evaluating the degree to which trend information about statistical quantities satisfying the input conditions are contained in a document searched by the search step, based on the occurrence status of the trend information elements in the document.

The computer-readable recording medium on which is recorded a trend information search program according to a third aspect of the present invention stores a program that causes a computer to execute:

an expanded query generation step for generating an expanded query by adding, as search conditions, trend information elements to the input search conditions, wherein the trend information element is a character string of natural language and characteristically appears in documents containing trend information;

a search step for searching external data using the query generated by the expanded query generation step; and

a trend information evaluation step for evaluating the degree to which trend information about statistical quantities satisfying the input conditions are contained in a document searched by the search step, based on the occurrence status of the trend information elements in the document.

### Efficacy of the Invention

With the present invention it is possible to automatically obtain, from an external corpus such as the Web and/or the like, statistical trend information related to a topic of interest to a user, even when the system does not possess those statistics.

### BRIEF DESCRIPTION OF DRAWINGS

FIG. 1 is a block diagram showing an exemplary composition of a search device according to a first preferred embodiment of the present invention;

FIG. 2 is a drawing showing an example of a screen into which search conditions are input according to the first preferred embodiment;

FIG. 3 is a drawing showing an example of a screen into which search conditions are input according to the first preferred embodiment;

FIG. 4 is a drawing showing an example of data recorded in a trend information memory in the first preferred embodiment;

FIG. 5 is a flowchart showing one example of a trend information search process according to the first preferred embodiment;

FIG. 6 is a block diagram showing an exemplary composition of a search device according to a second preferred embodiment of the present invention;

FIG. 7 is a drawing showing an example of data stored in a source document memory in the second preferred embodiment;

FIG. 8 is a drawing showing an example of a screen for displaying search results in the second preferred embodiment;

FIG. 9 is a flowchart showing one example of a trend information search process according to the second preferred embodiment;

FIG. 10 is a block diagram showing an exemplary composition of a search device according to a third preferred embodiment of the present invention;

FIG. 11 is a flowchart showing one example of a trend information search process according to the third preferred embodiment;

FIG. 12 is a drawing showing an example of data stored in a source document memory in the third preferred embodiment;

FIG. 13 is a block diagram showing an exemplary composition of a search device according to a fourth preferred embodiment of the present invention;

FIG. 14 is a drawing showing an example of data stored in a reputation information memory in the fourth preferred embodiment;

FIG. 15 is a flowchart showing one example of a trend information search process according to the fourth preferred embodiment; and

FIG. 16 is a block diagram showing an example of hardware composition in a search device according to preferred embodiments 1-4 of the present invention.

### MODE FOR CARRYING OUT THE INVENTION

Below, preferred embodiments for implementing the present invention are described in detail with reference to the drawings. In the drawings, parts that are the same or equivalent are labeled with the same reference numbers. First, the characteristics of a document containing statistical trend information that is a search target in the preferred embodiments will be described.

A sentence describing statistical trends is characterized in that expressions necessary for describing the statistical trends are expressed mutually as elements related to each other. These elements are called “trend information elements”. Contained in the “trend information elements” are topic words, statistical quantity names, period expressions, trend expressions, comparison expressions, unit expressions and/or the like.

A topic word is an expression indicating a topic that is a target of statistics. In “Company N's 2001 total sales”, “Company N” is a topic word.

A statistical quantity name is an expression indicating a type of statistical quantity that is a target of statistics. In “Company N's 2001 total sales”, “total sales” is a statistical quantity name.

A period expression is an expression indicating a period during which statistics were measured. In “Company N's 2001 total sales”, “2001” is a period expression.

A trend expression is an expression indicating an increase or decrease in the statistical quantity (value). Examples of trend expressions include “increase”, “decrease”, “level off”, “violent fluctuation”, “peak”, “bottom out” and/or the like.

A comparison expression is an expression used to compare a statistical quantity with some kind of standard. Specific examples of comparison expressions include “compared to the prior year”, “compared to the same period a year earlier”, “compared to the same month a year earlier”, “change” and/or the like.

A unit expression is an expression used to described the value of a statistical quantity. For example, if the statistical quantity relates to money, such as “total sales”, “net profit”, “GDP”, “annual household income” and/or the like, “trillion yen”, “hundred million yen”, “thousand yen”, “yen” and/or the like could be applicable. In addition, if the statistical quantity is “number of shipments”, “sales volume”, and/or the like, “hundred million units”, “thousand units”, hundred units”, “units” and/or the like could be applicable. Furthermore, if the statistical quantity relates to number of people, such as “total population”, “number of users” and/or the like, then “1 billion people”, “1 million people”, “1,000 people”, “person” and/or the like could be applicable.

In order to efficiently collect statistical trend information, it is necessary to search documents containing the above kind of trend information elements and to determine whether or not the trend information elements in those documents appear mutually related to each others.

### First Preferred Embodiment

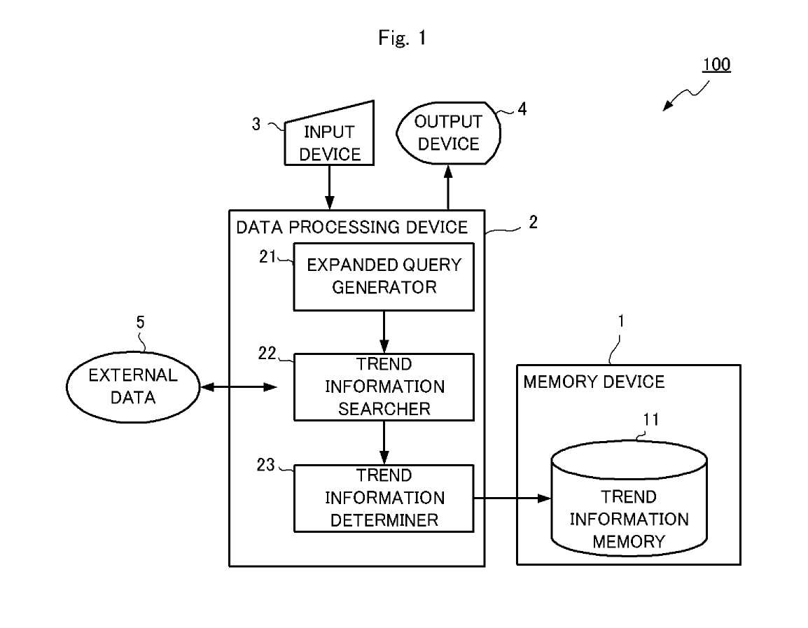

A search device 100 (trend information search device) according to a first preferred embodiment of the present invention comprises a memory device 1, a data processor 2, an input unit 3 and an output unit 4, as shown in FIG. 1.

The memory device 1 physically comprises a hard disk, a flash memory and/or the like, and functionally comprises a trend information memory 11.

The data processor 2 physically comprises a CPU and/or the like and is functionally composed of an expanded query generator 21, a trend information searcher 22 and a trend information determiner 23.

The input unit 3 comprises a keyboard and a pointing device such as a mouse. The input unit receives information input from a user and conveys this input information to the data processor 2.

The input unit receives from the user keywords indicating a topic that is a search target, a statistical quantity name relating to that topic and a period that is a statistical target as search conditions.

The output unit 4 comprises a display and/or the like. The output unit 4 displays a screen transmitted from the data processor 2.

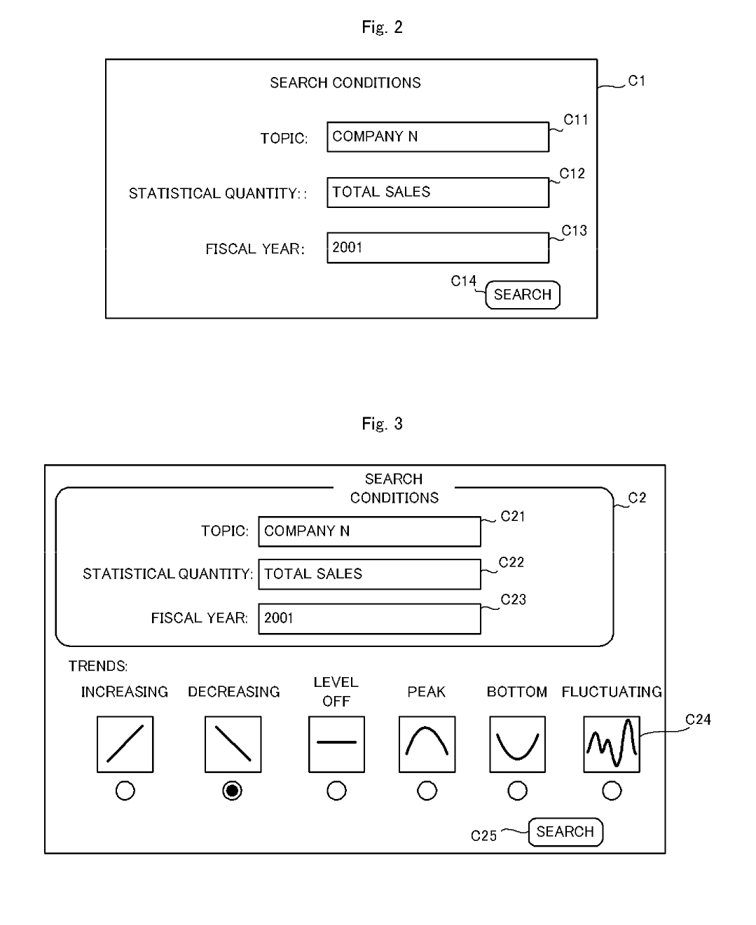

FIG. 2 shows an example of a screen for a user to inputs search conditions. A search condition input screen C1 in FIG. 2 includes a form C11 for receiving input of topic, a form C12 for receiving input of statistical quantity name a form C13 for receiving input of fiscal year, and a search button C14. When the user presses the search button C14, a search is executed using the search conditions input in forms C11 to C13 at that time. In FIG. 2, “Company N” has been input as the topic word, “total sales” as the statistical quantity name, and “2001” as the fiscal year.

The screen for inputting search conditions is not limited to the above-described example. For example, the period expression is not limited to fiscal year, but may be quarter, month, week and/or the like. In addition, the method for inputting the period expression may also be a method in which the dates of the start and end of the period are specified. In addition, it is also possible to use a method in which the user inputs a given event and either before or after the date that event occurred is the designated period.

The expanded query generator 21 generates a query for searching documents having a high likelihood of containing trend information related to the topic word, statistical quantity name and period expression the user input. An example of a simple method for generating a query is a method for generating a query linking the topic word, statistical quantity name and period expression with the operator AND. When this method is used, for example the query “Company N AND total sales AND 2001” is generated for the search conditions in FIG. 2. However, as noted above documents simply containing “Company N”, “total sales” and “2001” are not necessarily documents noting the fact that Company N's total sales declined in 2001. Hence, in order to obtain targeted trend information with greater probability, the expanded query generator 21 expand a query. The query expansion includes expansion by similar meaning terms, expansion by comparative expressions and expansion by units and the like.

A query expansion by similar meaning terms generates a query in which multiple similar meaning terms registered in advance in a thesaurus are connected by the operator OR. Query expansion by similar meaning term includes expansion through similar meaning term of the topic word, expansion through similar meaning term of the statistical quantity name, expansion by similar meaning term of the fiscal year expression, expansion by similar meaning term of trend expression and/or the like. For example, for the topic word “Company N”, when the query is expanded by the formal name “Nxxx” of Company N, which is a similar meaning term, the query becomes “Company N OR Nxxx”. For the statistical quantity name “total sales”, expansion of the query by the similar meaning term “income” results in a query of “total sales OR income”. For the period expression “2001”, expansion of the query by the similar meaning term “Heisei 13” results in the query “2001 OR Heisei 13”. When the query is expanded by the above-described similar meaning terms of all of the words input as search conditions in FIG. 2, the expanded query that results is “(Company N OR Nxxx) AND (total sales OR income) AND (2001 or Heisei 13)”.

A query expansion by trend expression generates a query in which typical expressions used in describing an increase or decrease in statistical quantities are connected by the operator OR. Examples of typical expressions used when describing an increase or decrease in a statistical quantity include “increase”, “decline” and/or the like. Furthermore, similar meaning terms of “increase” include “expansion”, “growth” and/or the like. Similar meaning terms of “decline” include “fall”, “shrink” and/or the like. For example, when the query is expanded by the above-described similar meaning terms of all words in the search conditions in FIG. 2 and is also expanded by the above-described trend expressions, the expanded query becomes “(Company N OR Nxxx) AND (total sales OR income) AND (2001 or Heisei 13) AND (increase OR expansion OR growth OR decline OR fall OR shrink)”.

The method of expanding a query by trend expression is not limited to the above-described example. For example, if the user already knows the trend in the target fiscal year of the statistical quantity that is the search target, a method is possible in which the user can limit the scope of the expansion by trend expression. A screen of the user inputting search conditions when this method is used is shown in FIG. 3.

Here, an explanation below is for an example when the user already knows that “Company N's total sales in 2001” were in a “declining” trend. In FIG. 3, the directions of the statistical information trend are displayed by an icon C24. In this example, the user pressed the search button C25 after selecting “decline”. The expanded query generator 21 responds to this and expands the query by trend expression using only expressions meaning “decline”. In this case, the expanded query becomes “(Company N OR Nxxx) AND (total sales OR income) AND (2001 or Heisei 13) AND (decline OR fall OR shrink)”.

Expansion of the query by a comparison expression means generating a query in which typical expressions used for comparing the statistical quantities changing with time are connected by the operator OR. Examples of typical expressions used for comparing the statistical quantities changing with time include “change”, “compared with the prior year”, “compared with the same period in the prior year”, and “compared with the same month in the prior year”. For example, when the query is expanded by the similar meaning terms in the search conditions in FIG. 3, and expanded by the trend expressions in the declining direction and is expanded by comparison expressions, the expanded query becomes “(Company N OR Nxxx) AND (total sales OR income) AND (2001 or Heisei 13) AND (decline OR fall OR shrink) AND (change OR compared with the prior year OR compared with the same period in the prior year OR compared with the same month in the prior year)”.

Expansion of the query by unit expression means generating a query in which units of the statistical quantity are connected by the operator OR. Which unit expressions correspond to which statistical quantities is defined and stored. The units corresponding to the statistical quantity “total sales” are “trillion yen”, “billion yen”, “million yen”, and/or the like. For example, when the query is expanded by the similar meaning terms in the search conditions in FIG. 3, and expanded by the trend expressions in the declining direction and expanded by comparison expressions and expanded by unit expressions, the expanded query becomes “(Company N OR Nxxx) AND (total sales OR income) AND (2001 or Heisei 13) AND (decline OR fall OR shrink) AND (change OR compared with the prior year OR compared with the same period in the prior year OR compared with the same month in the prior year) AND (trillion yen OR billion yen OR million yen)”.

The trend information searcher 22 searches external data 5 using the expanded query generated by the expanded query generator 21, and transmits the documents that are search results to the trend information determiner 23. The external data 5 are documents on the Internet or documents collected in document databases of an intranet. For the trend information searcher 22, a unique search means may be prepared or a means for executing a search using an external search engine may be prepared.

The trend information determiner 23 determines, for each document that is a search result transmitted from the trend information searcher 22, whether or not the document is a document containing trend information targeted by the user. To make this determination, the trend information determiner 22 evaluates the extent to which that document contains trend information. That evaluation is accomplished on the basis of the form in which trend information elements appear in the document. The form in which trend information elements appear in the document means, for example, the frequency with which the trend information elements appear, or the frequency with which a prescribed words pattern appears, or the frequency with which the trend information appears in the document title of the document.

The words pattern mentioned here indicates a type of words arrangement used for expressing a particular meaning in the documents containing the trend information. Specific examples of words patterns include “(topic word)'s (fiscal year)”, “(fiscal year)'s (topic word)”, “(fiscal year)'s (statistical quantity)”, “(statistical quantity)'s (fiscal year)” and/or the like.

In this preferred embodiment, the degree to which a document contains trend information elements is expressed as a total score S. The total score S is calculated from one or a combination of multiple scores of a topic score TS, a statistical quantity score SS, a period score PS, a trend score MS, a comparison score CS and a unit score US. Furthermore, the trend information determiner 23 creates data compiling the search keywords specified by the user, the document ID and the articles that are determination targets, and stores this data in the trend information memory 11.

The topic score TS is a score quantifying whether or not the document is one relating to the topic words selected by the user. The topic score TS can be computed using a frequency ts1 of topic words appearing in the document title, and a frequency ts2 of topic words appearing in the document. Specifically, TS can be computed from the weighted sum of ts1 and ts2, namely:

TS=W11*ts1+W12*ts2.

Here, the weighting W11 and the weight W12 are values determined arbitrarily based on experiment, and preferably W11>W12.

To facilitate understanding, the abovementioned case where the appearance frequency of the topic words themselves is used in calculating the topic score TS was explained. However, the method of computing the topic score TS is not limited to this. Other methods of computing the topic score TS include a method that adds the appearance frequency of words related to the topic words, or the method that adds the product of the appearance frequency and the relationship degree to the topic score TS. Words related to the topic words can be found as follows:

(1) Let G1 be the set of documents searched by the trend information searcher 22 using the expanded queries generated by the trend expression expander 21.

(2) Let G2 be the set of documents searched by the trend information searcher 22 using the query excluding the topic words and similar meaning terms thereof, out of the expanded queries generated by the trend expression expander 21.

(3) Let F_G1(t) be the appearance frequency of the word t in the set of documents G1, and F_G2(t) be the appearance frequency of the word t in the set of documents G2.

(4) Let R(t)=F_G1(t)/F_G2(t) be the relationship degree of the word t to the topic elements. Calculate R(t) for all words t contained in the document. Sort the words contained in the document in descending order by R(t), and call the top N words the words related to the topic words. Here, N is a prescribed natural number, and R(t) is the relationship degree thereof.

The statistical quantity score SS is a score quantifying whether or not descriptions relating to the statistical quantity input by the user are contained in the searched documents. The statistical quantity score SS can be calculated from the appearance frequency ss1 of the words pattern “(topic word)'s (statistical quantity)” in the document body, the appearance frequency ss2 of the statistical quantity in the document title, and the appearance frequency ss3 of the statistical quantity in the document body. Specifically, SS can be calculated as the weighted sum of ss1, ss2 and ss3 as follows:

SS=W21*ss1+W22*ss2+W23*ss3.

Here, the weighting W21, the weighting W22 and the weighting W23 are values arbitrarily determined based on experiment, and preferably W21>W22>W23.

The period score PS is a score quantifying whether or not there is a description related to the period input by the user in the searched document. In particular, the period score when a year is the unit of the period is called a fiscal year score YS. The fiscal year score YS can be calculated using ys1, ys2 and ys3. Here, ys1 is the appearance frequency in the document body of the words patterns (patterns of combinations of trend information elements) “(topic word)'s (fiscal year)”, “(fiscal year)'s (topic word)”, “(fiscal year)'s (statistical quantity)” and “(statistical quantity)'s (fiscal year)”. In addition, ys2 is the appearance frequency of fiscal year expressions in the document title. In addition, ys3 is the appearance frequency of fiscal year expressions in the document body. Here, the fiscal year score YS can be calculated as the weighted sum of ys1, ys2 and ys3, namely:

YS=W31*ys1+W32*ys2+W33*ys3.

Here, the weightings W31, W32 and W33 are values arbitrarily determined based on experiment, but preferably W31>W32>W33.

The period score PS can be defined in conformity to expanding the calculation method of the fiscal year score YS in a typical period expression. When the input period indicates a quarter or month, to find PS, not just elements expressing the specified quarter or month but expressions indicating the year including said period (naturally, including similar meaning terms thereof) also become targets of calculation. For example, a numerical value is calculated the same as the fiscal year score YS for the period element that was input. Next, the value about whether or not expressions indicating a year containing that period appear is calculated the same as the fiscal year score YS. Finally, the two values are weighted and summed, and through this the period score PS is computed.

The trend score MS is a score quantifying whether or not trend expressions input by the user appear in the searched document. The trend score MS can be calculated based on ms1, ms2 and ms3. Here, ms1 is the appearance frequency in the document body of the words pattern “(statistical quantity) (trend expression)”. In addition, ms2 is the appearance frequency of the trend expression in the document title. In addition, ms3 is the appearance frequency of the trend expression the document body. Here, the trend expression score MS can be calculated as a weighted sum of ms1, ms2 and ms3, namely:

MS=W41*ms1+W42*ms2+W43*ms3.

Here, the weightings W41, W42 and W43 are values arbitrarily determined based on experiment, but preferably W41>W42>W43.

The comparison score CS is a score quantifying whether or not comparison expressions such as “compared to the prior year” and “change” appear in the search result document. The comparison score CS can be calculated from cs1, cs2 and cs3. Here, cs1 is the appearance frequency in the document body of the words patterns “(statistical quantity) (comparison expression)” and “(statistical quantity)'s (comparison expression)”. In addition, cs2 is the appearance frequency of the comparison expression in the document title. In addition, cs3 is the appearance frequency of the comparison expression in the document body. Here, the comparison score CS can be calculated as a weighted sum of cs1, cs2 and cs3, namely:

CS=W51*cs1+W52*cs2+W53*cs3.

Here, the weightings W51, W52 and W53 are values arbitrarily determined based on experiment, but preferably W51>W52>W53.

The unit expression score US is a score quantifying whether or not unit expressions relating to the statistical quantity input by the user appear in the search result document. The unit score US can be calculated from us1, us2 and us3. Here, us1 is the appearance frequency in the document body of the words patterns “(statistical quantity) (numerical value) (unit)”, and “(statistical quantity) is (numerical value) (unit)”. In addition, us2 is the appearance frequency of the unit expression in the document title. In addition, us3 is the appearance frequency of the unit expression in the document body. Here, the unit score CS can be calculated as a weighted sum of us1, us2 and us3, namely:

CS=W61*us1+W62*us2+W63*us3.

Here, the weightings W61, W62 and W63 are values arbitrarily determined based on experiment, but preferably W61>W62>W63.

The trend information determiner accomplishes determinations using the total score S. The total score S is calculated using the topic score TS, the statistical quantity score SS, the fiscal year score YS, the trend expression score MS, the comparison expression score CS and the unit expression score US.

The total score S is a numerical value evaluating the degree to which that document contains trend information for statistical quantities satisfying the search conditions. The total score S can specifically be calculated as the weighted sum of the each score, namely:

S=W1*TS+W2*SS+W3*YS+W4*MS+W5*CS+W6*US.

The trend information determiner 23 determines that trend information is contained in that document when the total score S exceeds a predetermined threshold value θ. Here, the weightings W1 to W6 are values determined arbitrarily based on experiments.

The trend information determiner 23 stores documents determined to contain trend information in the trend information memory 11. In addition, the trend information determiner 23 counts the appearance frequency of trend expression elements in each paragraph in the document and stores paragraphs having the largest appearance frequency of trend expression elements in a trend information list in the trend information memory 11.

In order to facilitate understanding, in the above method explained, the topic score TS, the statistical quantity score SS, the fiscal year score YS, the trend expression score MS, the comparison expression score CS and the unit expression score US are calculated as a weighted sum of the frequency of matches to words patterns for each expression, the appearance frequency in the title and the appearance frequency in the document body. However, the method of calculating the various scores is not limited to this. In addition, the method of determining whether or not documents of search results contain trend information targeted by the user is not limited to the above-described example. The determination method for example may be a method using a pattern recognition technique. In this case, using the frequency of matches to words patterns of each expression, the appearance frequency in the title and the appearance frequency in the body as characteristic vectors, determination is made using a discriminator conducting instructor-led trained by documents containing commonly known trend information. At this time, examples of discriminators used include a support vector machine and a neural network.

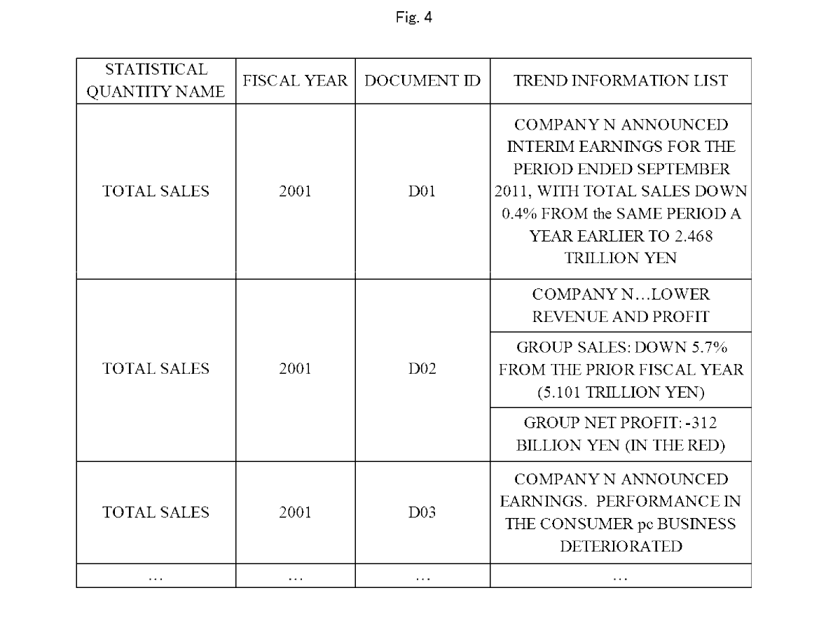

Trend information, which is searched by the trend information searcher 22 and determined to be trend information by the trend information determiner 23, is stored in the trend information memory 11 associated with the original document information. An example of data stored in the trend information memory 11 is shown in FIG. 4. In the example in FIG. 4, trend information for the fiscal year “2001” for the statistical quantity name “total sales” of the topic word “Company N” is described in document ID=D01. The basis for the document with document ID=D01 being trend information can be seen in the description that “Company N announced interim earnings for the period ending September 2001, and total sales declined 0.4% from the same period a year earlier to 2.468 trillion yen”. Here, the document ID is an identifier to identify each individual document, and can be an address indicating where the document body is, such as a URL (Uniform Resource Locator) or file bus, may be used.

In FIG. 4, topic word, statistical quantity name, fiscal year (period expression) document ID and trend information list are shown as examples of data stored in the trend information memory 11, but this is not limited to the contents described in this preferred embodiment. It would also be fine that store information also includes information about the contents of the document body indicated by the document ID, or the creation date or modification date of the document, or information about the creator, and/or the like.

The output unit 4 displays the trend information list (FIG. 4) stored in the trend information memory 11 as search results to the user.

This concludes the explanation of the functions of the search device 100. Next, the processes accomplished by the search device 100 are explained with reference to a flowchart.

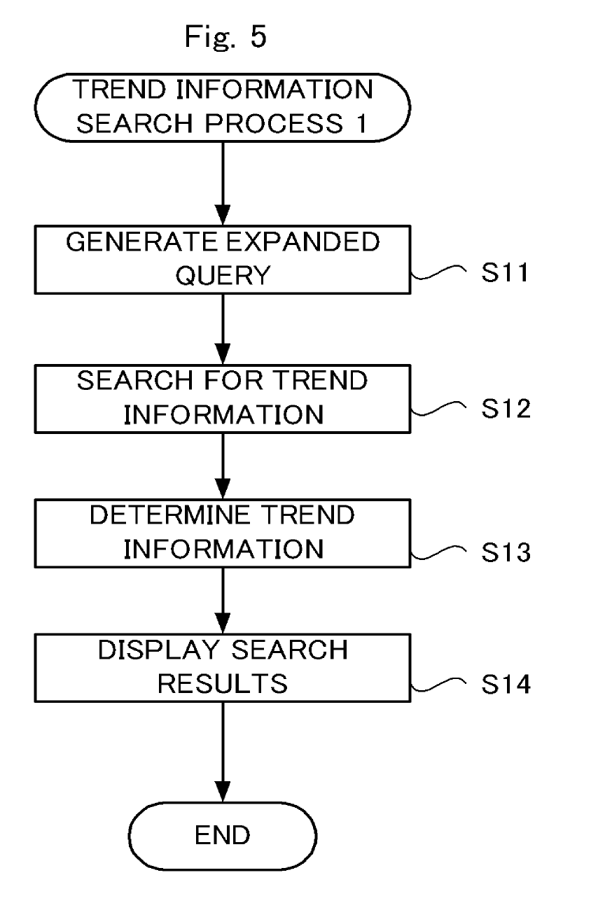

The series of processes (trend information search process 1) consisting of generating an expanded query, searching and determining the acquired documents are explained with reference to FIG. 5.

When a user inputs search conditions from the input unit 3 using the search condition input screen (C1, C2) of FIG. 2 or FIG. 3 and the search button is pressed, the trend information search process 1 is started.

First, the expanded query generator 21 generates a query by expanding the search conditions input in S11 (S11). Expansion of the search conditions is one or multiple expansion processes selected from expansion by similar meaning elements, expansion by trend elements, expansion by comparison elements and expansion by unit elements. The expanded query is transmitted to the trend information searcher 22.

For example, the process of S11 will be explained specifically for the example when the topic word “Company N”, the statistical quantity name “total sales”, and the fiscal year expression “2001” are input by the search condition input screen C1 of FIG. 2. The case where expansion by similar meaning elements, expansion by trend elements, expansion by comparison elements and expansion by unit elements are all accomplished will be explained as an example. At this time, the query becomes “(Company N OR Nxxx) AND (total sales OR income) AND (2001 or Heisei 13) AND (increase OR expand OR grow OR decline OR fall OR shrink) AND (change OR compared with the prior year OR compared with the same period in the prior year OR compared with the same month in the prior year) AND (trillion yen OR billion yen OR million yen)”. The combination of query expansion processes may be a predetermined arbitrary combination or may be a combination set by the user.

The trend information searcher 22 searches for external data 5 using the expanded query transmitted from the expanded query generator 21, and transmits search result documents to the trend information determiner 23 (S12).

Next, the trend information determiner 23 determines whether or not the trend information of the statistical quantity matching the search conditions specified by the user are described in each document in the search results document group transmitted from the trend information searcher 22 (S13). This determination is accomplished based on one or a combination of the topic score TS, the statistical quantity score SS, the fiscal year score YS, the trend expression score MS, the comparison expression score CS and the unit expression score US. The scores used may be predetermined scores or may be scores selected by the user. Furthermore, the trend information determiner 23 creates the data shown in FIG. 4 on the basis of the determination results, and stores that data in the trend information memory 11.

Finally, the data processor 2 displays the trend information list stored in the trend information memory 11 on the output unit 4 as search results (S14), and the process ends.

As explained above, the search device 100 according to the first preferred embodiment generates an expanded query using trend information elements based on topic words, statistical quantity names and period expressions input by the user, and searches external data for documents containing conforming trend information. In addition, a determination is made as to whether or not those documents contain trend information satisfying the search conditions input by the user based on the appearance status of trend information elements such as topic words, statistical quantity names, fiscal year (period expression), trend expressions, comparison expressions, unit expressions and/or the like. In this manner, the search device 100 can automatically acquire trend information for statistical quantities relating to topics in which the user is interested from an external corpus such as the Web, even when the system does not store the statistical quantity. The reason for this is that a query expanded by trend information elements from topic words and statistical quantity names input by the user is generated, documents containing conforming trend information are found from the external data, and an evaluation is made as to the degree to which these contain trend information satisfying the search conditions input by the user based on the occurrence status of trend information elements in the searched documents.

### Second Preferred Embodiment

Next, a second preferred embodiment of the present invention will be described. The search device 200 according to the second preferred embodiment are characterized, compared to the first preferred embodiment, by having a function for extracting and storing “cause documents” explaining the cause of trends in statistical quantities.

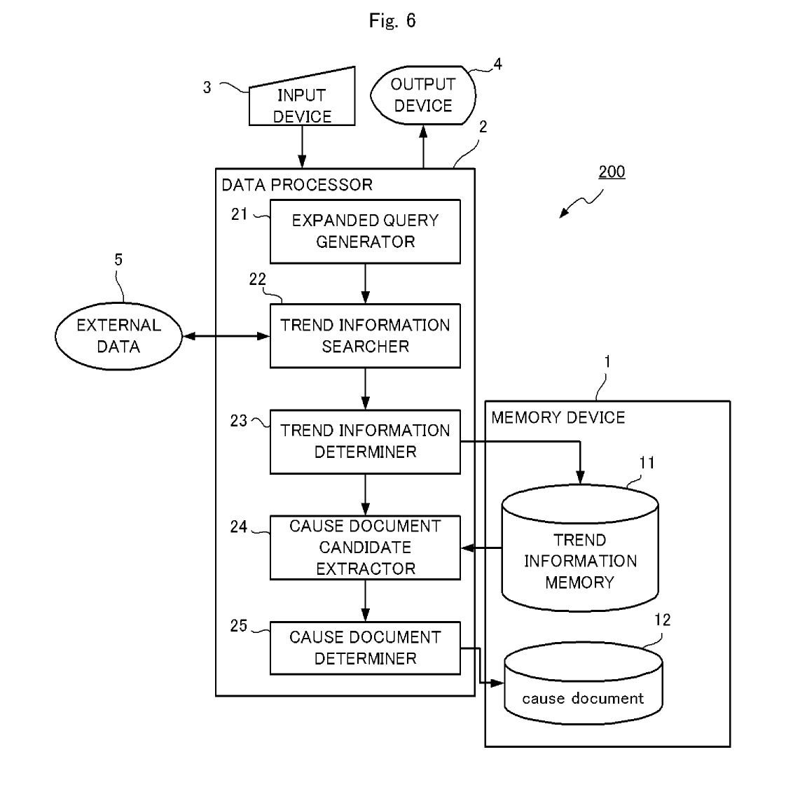

An exemplary composition of the search device 200 according to the second preferred embodiment will be explained with reference to FIG. 6. The search device 200 comprises, in addition to the composition of the search device 100 of the first preferred embodiment, a cause document memory 12, a cause document candidate extractor 24 and a cause document determiner 25.

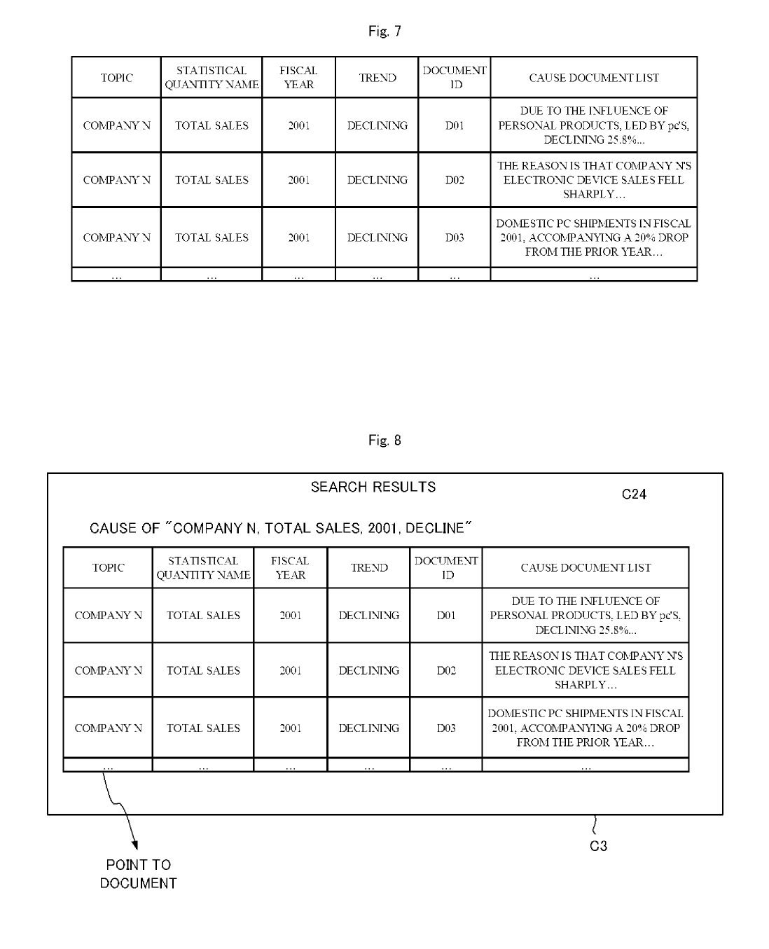

Documents extracted from the trend information memory 11 by the cause document candidate extractor 24 and determined to be documents explaining the cause of trend information by the cause document determiner 25 are stored in the cause document memory 12. FIG. 7 shows an example of data stored in the cause document memory. Looking at FIG. 7, it can be seen that the cause document of document D01 is the description “due to a 25.8% decline in personal products, primarily PCs”, wherein document D01 indicates “decline” in fiscal 2001 for the statistical quantity name “total sales” of the topic word “Company N”.

In FIG. 7, an example is shown of data in which the set of topic word, statistical quantity name, period expression, trend expression, document ID and cause document list is stored in the cause document memory 12. This is not limited to the contents described in this preferred embodiment. It would also be fine to store information also includes information about contents of the document body indicated by the document ID, or the creation date or modification date of the document, or information about the creator, and/or the like.

The cause document candidate extractor 24 extracts words patterns indicating cause, such as “effect”, “cause”, “because of . . . ”, “accompanying . . . ” and/or the like from the documents of the document set stored in the trend information memory 11. The cause document candidate extractor 24 transmits the extracted documents to the cause document determiner 25 as candidates of cause documents explaining the causes of trend information specified by the user.

The cause document determiner 25 determines whether or not each of the candidates of the cause documents transmitted from the cause document candidate extractor 24 are the cause documents. The determination is made using the following numerical values. These numerical values are the appearance frequency FT of topic words input by the user or words related thereto in that document, the appearance frequency FS of the statistical quantity expressions in that document, the appearance frequency FY of fiscal year expressions in that document, the appearance frequency FM of trend expressions in that document, the appearance frequency FC of comparison expressions in that document and the appearance frequency FU of unit expressions in that document. The cause document determiner 25 determines whether or not candidates of cause documents are cause documents explaining the cause of trend information specified by the user based on one or a combination of the above numerical values. The appearance frequency FY of the fiscal year expressions may in general be replaced by the appearance frequency of period expressions.

The cause document determiner 25 stores the search conditions specified by the user, the document ID and a list of the documents determined to be cause documents in the cause document memory 12.

The above-described determination is made using a total score F. The total score F is a score evaluating the degree to which the candidate of cause document is a cause document. The total score F is calculated, for example, from the weighted sum of the various scores, namely:

F=V1*FT+V2*FS+V3*FY+V4*FM+V5*FC+V6*FU.

When the total score exceeds a predetermined threshold value ω, the cause document determiner 25 determines that the candidate document is a cause document. The weightings V1 to V6 and the threshold value ω are prescribed values found experientially. The combination of scores used may be a predetermined arbitrary combination or may be a combination set by the user.

To facilitate understanding, an abovementioned method for calculating the total score F as a weighted sum of FT, FS, FY, FM, FC and FU was explained. However, the method of finding the total score F is not limited to this. In addition, the method of determining whether or not a candidate of cause document is a cause document is not limited to the above example. The determination method for example may be a method using a pattern recognition technique. In this case, using the number of matches to words patterns of each expression, the occurrence frequency in the title and the occurrence frequency in the body as characteristic vectors, determination is made using a discriminator conducting instructor-led training using documents containing commonly known trend information. At this time, examples of discriminators used include a support vector machine and a neural network.

The output unit 4 integrates the trend information list stored in the trend information memory 11 and the cause document list stored in the cause document memory 12 and displays such as search results. FIG. 8 shows an example of a screen displaying the search results. The search results screen example of FIG. 8 displays as a list the documents determined to contain trend information and cause documents. In addition, the document ID areas are configured as links, and by clicking these areas, the user can access the document bodies.

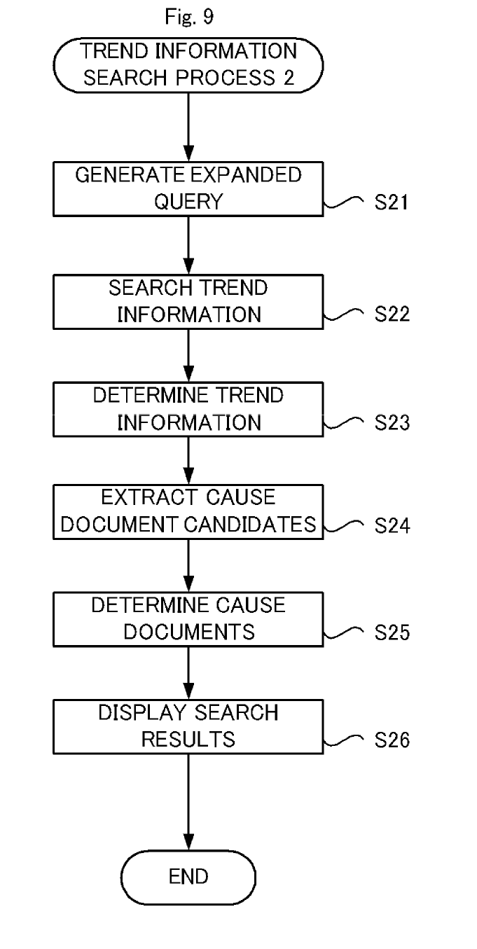

Next, the series of processes (trend information search process 2) for generating an expanded query, searching trend information and determining cause documents in the search device 200 will be explained with reference to FIG. 9.

The trend information search process 2 differs from the trend information search process 1 of the first preferred embodiment shown in FIG. 5 in containing a cause document candidate extraction process (S24) and a cause document determination process (S25). In the trend information search process 2, the processes of S21 to S23 are the same as the processes in steps S11 to S13 of the trend information search process 1 shown in FIG. 5.

When the trend information is stored in the trend information memory 11 by the trend information determiner 23, the cause document candidate extractor 24 extracts candidates of cause documents from the various documents of the document group stored in the trend information memory 11. The documents extracted are documents containing words patterns indicating cause, such as “effect”, “cause”, “reason”, because of . . . ”, “accompanying . . . ” and/or the like. The cause document candidate extractor 24 transmits the extracted candidates of cause document to the cause document determiner 25 (S24).

Next, the cause document determiner 25 determines whether or not each of the candidate of cause document extracted by the cause document candidate extractor 24 is a cause document (S25). This determination is made using the total score F calculated from the following numerical values. These numerical values are one or a combination of the appearance frequency FT of topic words input by the user or words related thereto in the document, the appearance frequency FS of statistical quantity expressions, the appearance frequency FY of fiscal year expressions, the appearance frequency FM of trend expressions, the appearance frequency FC of comparison expressions and the appearance frequency FU of unit expressions. The combination of numerical values used may be a predetermined arbitrary combination or may be a combination set by the user. The cause document determiner 25 creates the list shown in FIG. 7 from the determination results and stores that list in the cause document memory 12.

Finally, the data processor 2 integrates the trend information list stored in the trend information memory 11 and the cause document list stored in the cause document memory 12 and displays such on the output unit 4 as search result (S27), and the process ends.

As explained above, the search device 200 of the second preferred embodiment extracts candidates for cause documents explaining the cause of trend information based on words patterns expressing causes, and determines whether or not these are cause documents from the appearance frequency of trend information elements. In this manner, it is possible to extract cause documents explaining trend information, for trend information automatically acquired from an external corpus such as the Web.

### Third Preferred Embodiment

Next, a third preferred embodiment will be explained. A search device 300 according to the third preferred embodiment is characterized by comprising a fiscal year expression expander 26 in addition to the composition explained for the second preferred embodiment, as shown in FIG. 5. The composition other than this is the same as the second preferred embodiment.

The fiscal year expression expander 26 generates a fiscal year expression query corresponding to the fiscal year and each of the fiscal years in contiguous Y years before and after the fiscal year input by the user. And for each fiscal year, the fiscal year expression expander 26 orders downstream so as to repeatedly accomplish a trend information search process, a trend information determination process, a cause document candidate extraction process and a cause document determination process.

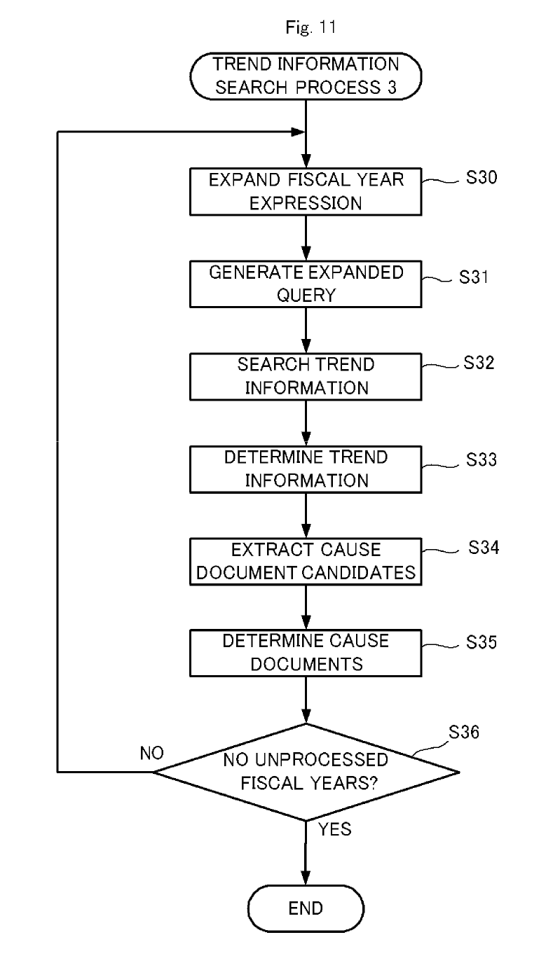

Next, the series of processes (trend information search process 3) accomplished in the search device 300 will be explained with reference to FIG. 11.

FIG. 11 is a flowchart showing the series of actions in the trend information search according to the third preferred embodiment. The process of the third preferred embodiment is the different from process of the second preferred embodiment shown in FIG. 9 in the point that process of this embodiment also comprises a fiscal year expression expansion process (S30) and a process for confirming whether or not the search process has ended for all expanded fiscal years (S36).

First, the fiscal year expression expander 26 expands the search conditions to the fiscal years Y years before the fiscal year input by the user and generates a query according to the fiscal year expression corresponding to the fiscal years that are process targets (step S30). For example, a specific explanation is given using an example in which the fiscal year input by the user as a search condition is 2001 and Y=3. In this case, the search target is the period from fiscal 1998 to fiscal 2004. The search process is executed for the seven years from fiscal 1998 to fiscal 2004. The fiscal year query used in the initial search is “fiscal 1998”, and the second is “fiscal 1999”.

Following this, the trend expression expander 21 generates an expanded query using the fiscal year query generated by the fiscal year expression expander 26 (S31).

Following this, the trend information searcher 22, the trend information determiner 23, the cause document candidate extractor 24 and the cause document determiner 25 execute a trend information search (S32), a trend information determination (S33), a cause document candidate extraction (S34) and a cause document determination (S35). The processes in steps S32 through S35 are the same as the processes in steps S22 through S25 in FIG. 9.

Next, the fiscal year expression expander 26 checks whether or not the processes have been accomplished for all fiscal years contained in the expanded period (step S36). If any unprocessed fiscal years remain (step S36: No), the process target is set to the next fiscal year, the process returns to step S30 and the processes are repeated starting at the trend expression expansion. When the process has been completed for all fiscal years contained in the expanded period (step S36: Yes), the process ends.

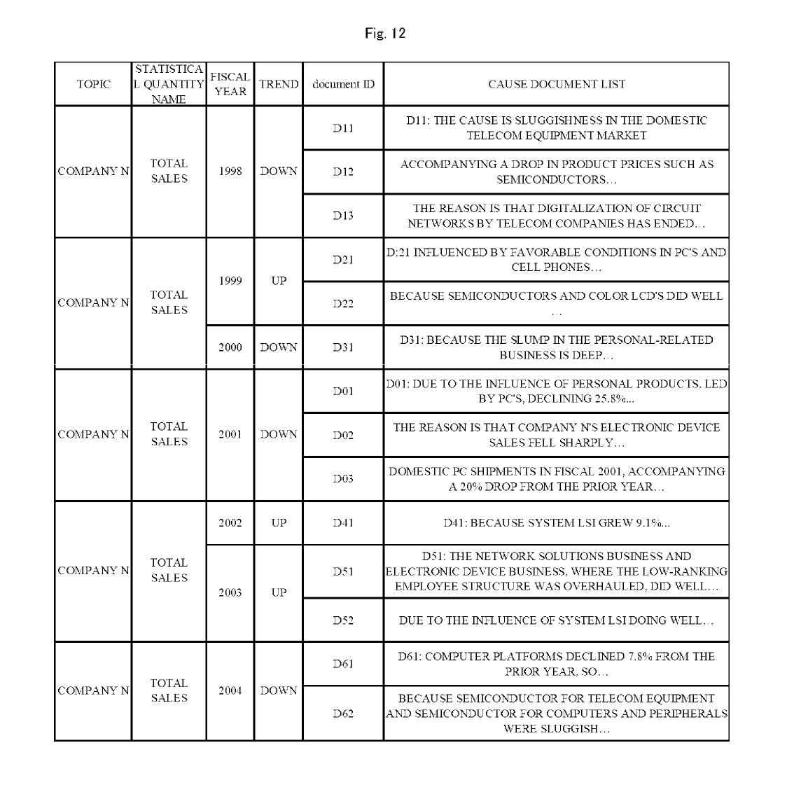

An example of the data stored in the cause document memory in the third preferred embodiment is shown in FIG. 12. Looking at FIG. 12, it can be seen that Company N's total sales increase and decrease due to varying causes from 1998 to 2004.

To facilitate understanding, the process was explained using an example in which the unit of periods for searching trend information is set to years. However, the period unit is not limited to years. For example, the period expression may be in units of quarters, months, weeks and/or the like, and may also be an expression setting the initial and ending dates of the period. In this case, in place of the fiscal year expression expander 26 the period expander expands the period that is the search target to a prescribed range before and after, using as units the designated period.

As explained above, the search device 300 of the third preferred embodiment generates and searches with expanded queries repeatedly over a prescribed range before and after the period input by the user, and extracts trend information and cause documents. Consequently, the user can understand trends in statistical quantities and changes in causes of these trends before and after the period in which the user is interested.

### Fourth Preferred Embodiment

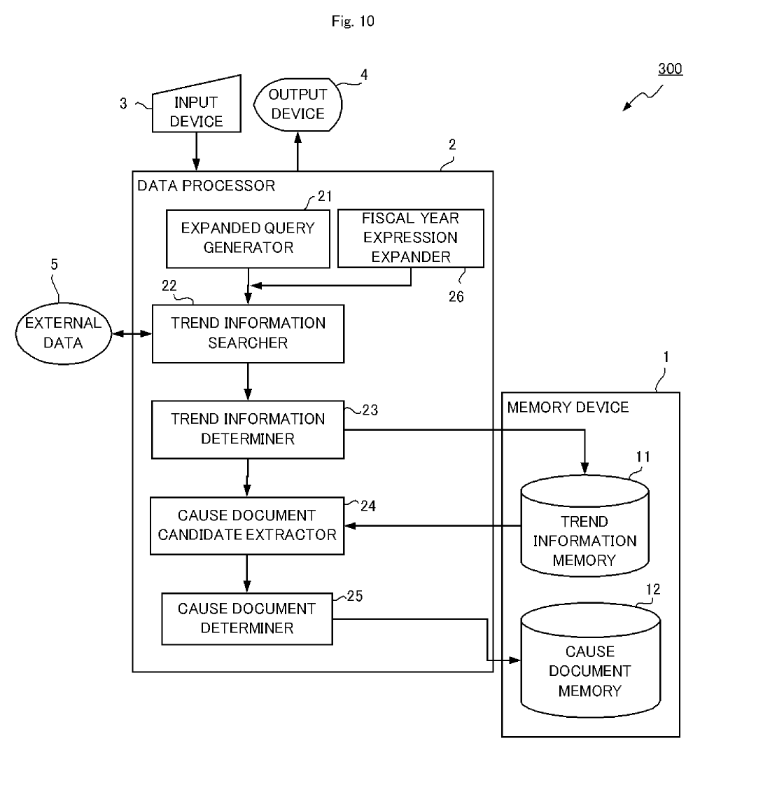

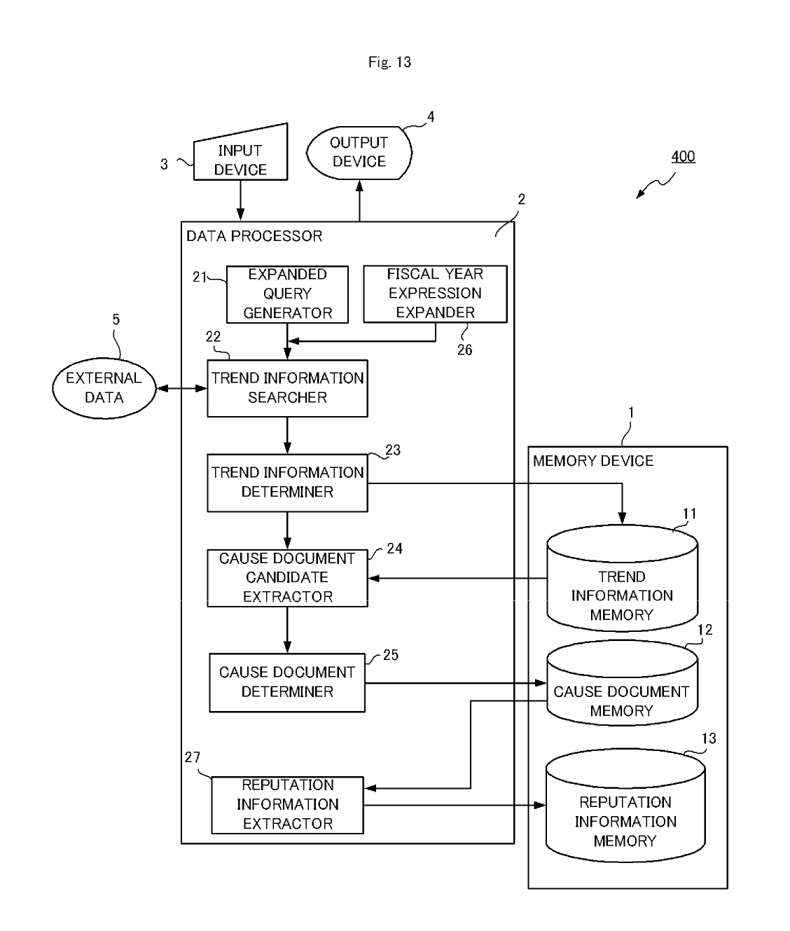

Next, a fourth preferred embodiment of the present invention will be explained. First, an exemplary composition of the search device 400 according to the fourth preferred embodiment will be explained with reference to FIG. 13. The composition of the search device 400 differs from the composition of the search device 300 shown in FIG. 10 in also comprising a reputation information extractor 27 and a reputation information memory 13. The composition other than this is the same as the third preferred embodiment.

The reputation information extractor 27 extracts sender information of documents for which cause documents were extracted, and determines whether or not reputation in the documents is positive or negative. A reputation determiner stores the determination results in the reputation information memory 13.

At this time, the sender information is the domain name of the Web site, document meta-information, signatures noted in news articles, and/or the like.

In addition, examples of the reputation information determination method include a method using a positive expression dictionary and a negative expression dictionary that are stored. The positive expression dictionary includes positive expressions such as “wonderful”, “favorable” and “good”. The negative expression diction includes negative expressions such as “sluggish”, “deteriorating” and “dull”. In this example, if the ratio FP/FN of the appearance frequency FP of positive expressions to the appearance frequency FN of negative expressions in the document is 1 or greater, positive reputation is determined, while if this ratio is less than 1, negative reputation is determined

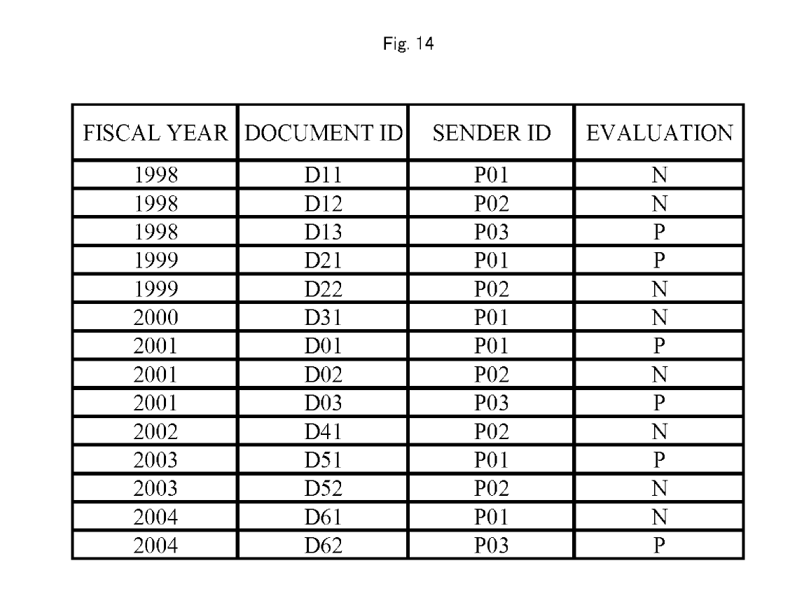

The reputation information memory 13 stores the information of fiscal year, document ID, sender ID and reputation as additional information relating to the documents stored in the cause document memory 12. FIG. 14 shows an example of the data stored in the reputation information memory. In the example in FIG. 14, it can be seen that a sender P01 sends positive or negative reputation documents for a particular fiscal year, but a sender P02 constantly sends negative documents regardless of fiscal year. And a sender P03 constantly sends positive documents regardless of fiscal year.

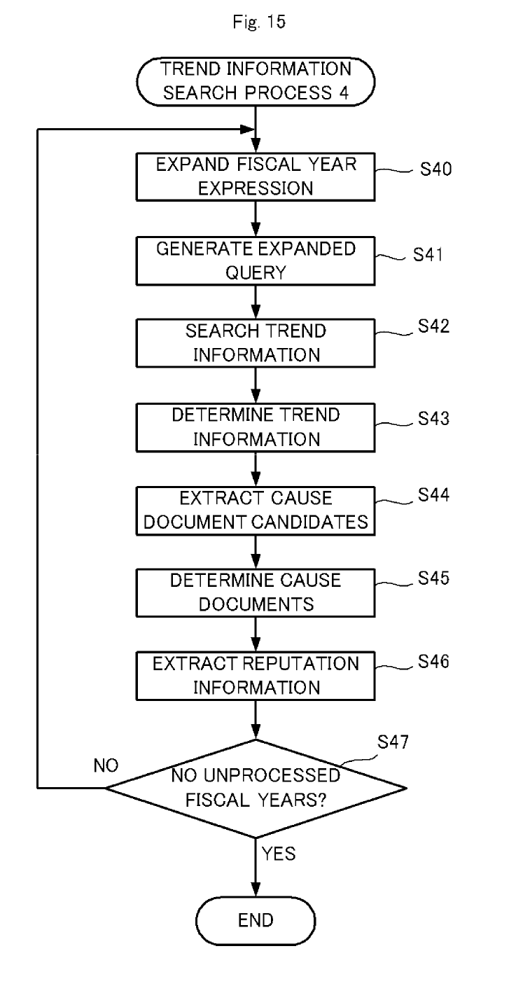

Next, the series of processes (trend information search process 4) accomplished in the search device 400 will be explained with reference to FIG. 15. The trend information search process of the fourth preferred embodiment differ from those of the third trend information search process 3 shown in FIG. 11 in containing a reputation information extraction process (S46).

When the user presses the search execution button, the trend information search process 4 is started. In the trend information search process 4, the process contents from the fiscal year expression expansion process (S40) through the cause document determination S(45) are the same as the actions of S30 to S35 in FIG. 11.

When the cause documents determined by the cause document determiner 25 are stored in the cause document memory 12 (step S45), the reputation information extractor 27 extracts sender information for documents from which the cause documents are extracted. Next, the reputation information extractor 27 determines whether the reputation in this document is positive or negative. Furthermore, the reputation information extractor 27 stores the determination results in the reputation information memory 13 (S46).

If the process is not ended for all fiscal years contained in the expanded period (step S47: No), the process returns to step S40, the process target is set to the next fiscal year and the processes are repeated starting with trend expression expansion. If the process is ended for all fiscal years contained in the expanded period (step S47: Yes), the process ends.

As explained above, the search device 400 according to the fourth preferred embodiment extracts sender information for documents for which cause documents are extracted, and determines whether or not reputation in the documents is positive or negative. Through this, the user can understand the change in what kind of reputation documents a sender was sending in each fiscal year.

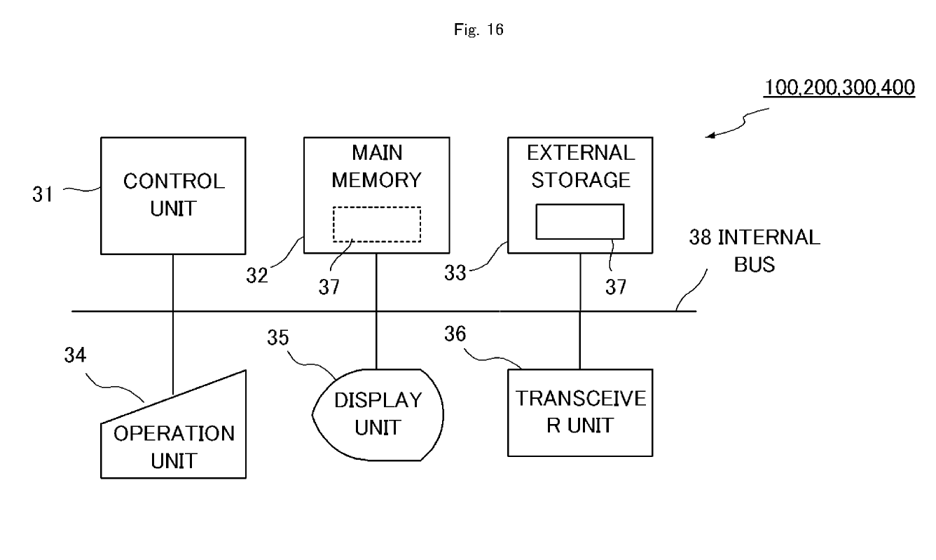

FIG. 16 shows an example of the hardware composition of the search device (search device 100, search device 200, search device 300 and search device 400) according to the preferred embodiments of the present invention. The search device (search device 100, search device 200, search device 300 and search device 400) is comprised of a control unit 31, a main memory 32, an external memory 33, an operation unit 34, a display unit 35 and a transceiver unit 36, as shown in FIG. 16. The main memory 32, the external memory 33, the operation unit 34, the display unit 35 and the transceiver unit 36 are all connected to the control unit via an internal bus 38.

The control unit is composed of a CPU (Central Processing Unit) and/or the like. The control unit 31 executes processes in accordance with a trend information search program 37 stored in the external memory 33.

The main memory 32 is composed of RAM (Random Access Memory) and/or the like. The main memory 32 loads the trend information search program 37 stored in the external memory 33 and is used as a work area for the control unit 31.

The external memory 33 is composed of flash memory, a hard disk, a DVD-RAM (Digital Versatile Disc Random Access Memory), a DVD-RW (Digital Versatile Disc ReWritable) and/or the like. The external memory 33 stores in advance the trend information search program 37. In addition, the external memory 33 supplies stored data to the control unit 31 and stores data supplied from the control unit 31, in accordance with commands from the control unit 31.

The trend information memory 11, the cause document memory 12 and the reputation information memory 13 are composed of memory regions reserved in the external memory 33. In addition, all or a portion of the trend information memory 11, the cause document memory 12 and the reputation information memory 13 are composed temporarily of a portion of a memory area of the main memory 32.

The operation unit 34 is composed of a keyboard and a pointing device such as a mouse and/or the like, and an interface device connecting the keyboard and pointing device and/or the like to the internal bus 38. Using the operation unit 34, the user accomplishes input of trend information on the keyboard, and/or the like.

The display unit 35 is composed of a CRT (Cathode Ray Tube) or an LCD (Liquid Crystal Display) and/or the like. The display unit displays a screen for inputting search keywords or search results. The display unit 35 may also be composed of a printer and an interface device thereof.

The transceiver unit 36 is composed of a communication device, and a serial interface or LAN (Local Area Network) interface connected thereto. The transceiver unit 36 sends queries to search engines on the Internet or document databases on the Internet and receives document data of search results, via a network (unrepresented).

The functions of the expanded query generator 21, the trend information searcher 22, the trend information determiner 23, the cause document candidate extractor 24, the cause document determiner 25, the fiscal year expression expander 26 and the reputation information extractor 27 are realized by executing the trend information search program 37 using the control unit 31, the main memory 32, the external memory 33, the operation unit 34, the display unit 35 and the transceiver unit 36.

The above-described hardware composition and flowchart are but one example. The hardware composition and execution process can be arbitrarily changed or altered without deviating from the scope of the present invention.

For example, the portion that is central to accomplishing the processes for a search device composed of the control unit 31, the main memory 32, the main memory 33, the transceiver unit 36 and/or the like can be realized without a specialized system by using a normal computer system. For example, it would be fine for a computer program for executing the above-described actions to be stored on and distributed by a computer-readable recording medium (flexible disk, CD-ROM, DVD-ROM and/or the like) and for a search device executing the above-described processes to be composed by installing this computer program on a computer. In addition, this computer program may be stored in a memory device 1 possessed by a server device on a communications network such as the Internet and/or the like, and the search device may be composed by downloading this onto a normal computer system.

In addition, the functions of the search device may be divided between an OS (operating system) and application programs, and in addition, when these are realized through cooperation between an OS and application programs, the application program portion alone may be stored on a recording medium and the memory device 1.

In addition, the computer program can be superimposed on carrier waves and distributed via a communication network. For example, the above-described computer program may be posted on a BBS (Bulletin Board System) on a communication network and the above-described computer program may be distributed via the network. Furthermore, the composition may be such that the above-described processes can be executed by launching this computer program and similarly executing other application programs under the control of the OS.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

This application claims the benefit of Japanese Patent Application 2010-009085, filed 19 Jan. 2010, the entire disclosure of which is incorporated by reference herein.

### INDUSTRIAL APPLICABILITY

The search device of the present invention can be used to collect corporate earnings, stock price movements, or assessment materials when analyzing the cause of changes in macroeconomic indicators.

### EXPLANATION OF SYMBOLS

1 Memory device
2 Data processor
3 Input device
4 Output device
11 Trend information memory
12 Cause document memory
13 Reputation information memory
21 Expanded query generator
22 Trend information searcher
23 Trend information determiner
24 Cause document candidate extractor
25 Cause document determiner
26 Fiscal year expression expander
27 Reputation information extractor
31 Control unit
32 Main memory
33 External memory
34 Operation unit
35 Display unit
36 Transceiver unit
37 Trend information search program
38 Internal bus
100 Search device
200 Search device
300 Search device
400 Search device

1-10. (canceled)

11. A trend information search device for searching trend information for statistical quantities, said trend information search device comprising:
an expanded query generator that generates an expanded query by adding, as search conditions, trend information element to the input search conditions containing the search keyword, wherein the trend information element is a character string of a natural language not being included in the search keywords and characteristically appears in documents containing the trend information;
a searcher that searches external document data using the expanded query generated by the expanded query generator; and
a trend information evaluator that evaluates the degree to which the trend information for the statistical quantities satisfying the input conditions are contained in a document searched by the searcher, based on the occurrence status of the trend information element and the input search keyword in the document.

12. The trend information search device according to claim 11, wherein:
the trend information element is at least one of topic words, statistical quantity names, period expressions, trend expressions, comparison expressions or unit expressions, or combinations thereof; and
the expanded query generator generates the query using a term which has a similar meaning to the trend information elements.

13. The trend information search device according to claim 11, wherein:
the trend information elements are at least one of topic words, statistical quantity names, period expressions, trend expressions, comparison expressions or unit expressions, or combinations thereof; and
the trend information evaluator evaluates the degree to which the trend information for statistical quantities satisfying the input conditions are contained, based on the occurrence status of a term which has similar meaning to the trend information elements.

14. The trend information search device according to claim 13, wherein the trend information evaluator evaluates the degree to which the trend information for statistical quantities satisfying the input conditions are contained through a sore calculated from a frequency with which the trend information elements and the term which has the similar meaning to thereof and specified word patterns occur in the document.

15. The trend information search device of claim 11, further comprising:
a cause document candidate extractor that extracts one or more documents containing word patterns indicating cause from the document searched by the searcher, and makes candidates of the cause documents, wherein the cause document explains cause of trends of the statistical quantities satisfying the input conditions; and
a cause document evaluator that evaluates the degree to which the candidates of the cause documents are the cause documents explaining the causes of the trends of the statistical quantities, based on the occurrence frequency of the trend information elements.

16. The trend information search device according to claim 15, wherein the trend information element is at least one of topic words, statistical quantity names, period expressions, trend expressions, comparison expressions or unit expressions, or combinations thereof.

17. The trend information search device according to claim 15, further comprising a reputation information extractor that extracts information about a sender of document for which the candidates of the cause documents were extracted by the cause document candidate extractor and evaluates whether a reputation in the extracted documents is positive or negative.

18. The trend information search device of claim 11, further comprising a period expression expander that generates a query by expanding period of the input condition before and after to a period containing the period of the input condition.

19. A trend information search method for searching trend information for statistical quantities, said trend information search method comprising:
an expanded query generation step for generating an expanded query by adding, as search conditions, trend information element to the input search conditions containing the search keyword, wherein the trend information element is a character string of a natural language not being included in the search keywords and characteristically appears in documents containing the trend information;
a search step for searching external document data using the expanded query generated by the expanded query generation step; and
a trend information evaluation step for evaluating the degree to which the trend information for the statistical quantities satisfying the input conditions are contained in a document searched by the search step, based on the occurrence status of the trend information element and the input search keyword in the document.

20. A computer-readable recording medium on which is recorded a trend information search program that causes a computer to execute:
an expanded query generation step for generating an expanded query by adding, as search conditions, trend information element to the input search conditions containing the search keyword, wherein the trend information element is a character string of a natural language not being included in the search keywords and characteristically appears in documents containing the trend information;
a search step for searching external document data using the expanded query generated by the expanded query generation step; and
a trend information evaluation step for evaluating the degree to which the trend information for the statistical quantities satisfying the input conditions are contained in a document searched by the search step, based on the occurrence status of the trend information element and the input search keyword in the document.

21. The trend information search device of claim 12, further comprising:
a cause document candidate extractor that extracts one or more documents containing word patterns indicating cause from the document searched by the searcher, and makes candidates of the cause documents, wherein the cause document explains cause of trends of the statistical quantities satisfying the input conditions; and
a cause document evaluator that evaluates the degree to which the candidates of the cause documents are the cause documents explaining the causes of the trends of the statistical quantities, based on the occurrence frequency of the trend information elements.

22. The trend information search device of claim 13, further comprising:
a cause document candidate extractor that extracts one or more documents containing word patterns indicating cause from the document searched by the searcher, and makes candidates of the cause documents, wherein the cause document explains cause of trends of the statistical quantities satisfying the input conditions; and
a cause document evaluator that evaluates the degree to which the candidates of the cause documents are the cause documents explaining the causes of the trends of the statistical quantities, based on the occurrence frequency of the trend information elements.

23. The trend information search device of claim 14, further comprising:
a cause document candidate extractor that extracts one or more documents containing word patterns indicating cause from the document searched by the searcher, and makes candidates of the cause documents, wherein the cause document explains cause of trends of the statistical quantities satisfying the input conditions; and
a cause document evaluator that evaluates the degree to which the candidates of the cause documents are the cause documents explaining the causes of the trends of the statistical quantities, based on the occurrence frequency of the trend information elements.

24. The trend information search device according to claim 16, further comprising a reputation information extractor that extracts information about a sender of document for which the candidates of the cause documents were extracted by the cause document candidate extractor and evaluates whether a reputation in the extracted documents is positive or negative.

25. The trend information search device of claim 12, further comprising a period expression expander that generates a query by expanding period of the input condition before and after to a period containing the period of the input condition.

26. The trend information search device of claim 13, further comprising a period expression expander that generates a query by expanding period of the input condition before and after to a period containing the period of the input condition.

27. The trend information search device of claim 14, further comprising a period expression expander that generates a query by expanding period of the input condition before and after to a period containing the period of the input condition.

28. The trend information search device of claim 15, further comprising a period expression expander that generates a query by expanding period of the input condition before and after to a period containing the period of the input condition.

29. The trend information search device of claim 16, further comprising a period expression expander that generates a query by expanding period of the input condition before and after to a period containing the period of the input condition.

30. The trend information search device of claim 17, further comprising a period expression expander that generates a query by expanding period of the input condition before and after to a period containing the period of the input condition.
